(19) United States
(12) Patent Application Publication
(10) Pub. No.: US 2016/0342374 A1
(43) Pub. Date: Nov. 24, 2016

(54) DOUBLE-SIDED DISPLAY MODULE WITH OPTICALLY FUNCTIONAL FILM

(71) Applicants: Raymond Wang, Taichung City (TW); RayShine Photonics Corp., Taichung City (TW)

(72) Inventor: Raymond Wang, Taichung City (TW)

(21) Appl. No.: 14/958,450

(22) Filed: Dec. 3, 2015

(30) Foreign Application Priority Data
May 21, 2015 (TW) 104116199

(51) Int. Cl. G06F 3/14; F21V 8/00; G02F 1/1335; G02F 1/133

(52) U.S. Cl. CPC G06F 3/1423; G02F 1/13306; G02B 6/005; G02B 6/0051; G02B 6/0056; G02B 6/0076; G02F 1/133555; G02B 6/0053; G02F 2001/133342

(57) ABSTRACT

A double-sided display module with two optically functional films includes a double-sided display panels, a lighting module, and a display controller. The double-sides display panel includes two oppositely disposed display panels, a light guide module, and two optically functional films. Each of the optically functional films includes a first transformation layer, a second transformation layer, a diffusion layer, a brightness enhancement layer, and a polarized layer, and each layer of the optically functional film is attached to each other by transfer-coating process. Therefore, the thickness of the optically functional film can be reduced, so that the cost of manufacturing the double-sided display module with the optically functional films is saved and the volume of the double-sided display module is reduced as well without reducing brightness.

### FIELD OF THE INVENTION

The present invention relates a display module, particularly, relates a double-sided display module with optically functional film.

### BACKGROUND OF THE INVENTION

With science progress, a light volume for easy portability and arrangement is a trend for the development of liquid display. Furthermore, liquid crystal display would be applied to various fields, such as portable display, large-scale display for outdoor or indoor shows, desktop display or automotive display. However, no matter what applications, the volume and the cost reduction of liquid crystal display are always issues that need to be resolved.

Now double-sided liquid crystal display has been developed for simultaneously controlling two liquid displays by a controller. Back-to-back type is a general design for the two liquid crystal displays; one is a main screen; and the other is an auxiliary screen. Such a double-sided liquid crystal display may be applied to both large scale shows for serving more viewers and a service entrance of an administration government for the viewing convenience of both administration civil servants and requesters.

Besides, internal components of a backlight module for a display mainly consist of a lighting element, a light guide plate, an optical conversion film, a diffusion film, and a brightness enhancement film. These individual optical components that include the optical conversion film, the diffusion film, and the brightness enhancement film necessitate assembly. Furthermore, matching among them should be considered during the assembly. Moreover, air gaps among these optical components should be reserved in advance during the assembly for the sake of their efficiently optical performances. However, light traveling in an optical path with the air gaps may have intensity loss because of scattering and reflection. Consequently, a structure with the air gaps not only raises the thickness of a liquid display but also causes the brightness reduction of the liquid display. Accordingly, it is an issue to reduce the whole thickness of these optical components in consideration of maintaining display brightness.

### SUMMARY OF THE INVENTION

For resolving present drawbacks, a double-sided display module with an optically functional film is provided. Multiple components of an optically functional film, which include a first conversion layer, a second conversion layer, a brightness enhancement layer, a diffusion layer, and a polarization layer are integrated by the way of matching reflection indexes and formed by a transfer-coating process. Without the sacrifice of the brightness of a display module, aforementioned approach can reduce the thickness of the optically functional film and the whole volume of the double-sided display module.

Accordingly, the present invention provides a double-sided display module with an optically functional film, including: a double-sided display comprising: a first display panel; a first optically functional film with a thickness from 0.4 mm to 1.4 mm, the first optically functional film deposited on the first display panel; a light guide module deposited on the first optically functional film; a second optically functional film with a thickness from 0.4 mm to 1.4 mm, the second optically functional film deposited on the light guide module; and a second display panel deposited on the second optically functional film; a lighting module deposited at one side of the double-sided display, the lighting module configured to emit point light to the light guide module of the double-sided display; and a display controller electrically coupled to the first display panel and the second display panel of the double-sided display, the display controller outputting power and signal to the double-sided display; wherein the first optically functional film and the second optically functional film respectively comprise: a first conversion layer having an upper surface of a prism structure and a flat bottom surface, the first conversion layer configured to convert point light into linear light and output the linear light; a second conversion layer having an upper surface of a prism structure and a flat bottom surface, the second conversion layer deposited onto the first conversion layer and configured to convert the linear light from the first conversion layer into area light and output the area light; and a diffusion layer having a flat upper surface and a flat bottom surface, the diffusion layer deposited onto the second conversion layer and configured to homogenize the area light from the second conversion layer; and wherein both the first optically functional film and the second optically functional film are respectively attached to the light guide module with the first conversion layer; and wherein display screen direction of the first display panel differs 180 degrees from display screen direction of the second display panel.

The display module with an optically functional film, wherein the upper surface of the first conversion layer and the bottom surface of the second conversion layer are attached to each other with their respective edges, an air gap is formed between the upper surface of the first conversion layer and the bottom surface of the second conversion layer, the flat bottom surface of the diffusion layer and the upper surface of the second conversion layer are attached to each other with their respective edges, and an air gap is formed between the flat bottom surface of the diffusion layer and the upper surface of the second conversion layer.

The display module with an optically functional film, wherein the first optically functional film further comprises a brightness enhancement layer, the brightness enhancement layer comprises a flat upper surface and a flat bottom surface, the flat bottom surface of the brightness enhancement layer and the flat upper surface of the diffusion layer are attached to each other with a first optical cement.

The display module with an optically functional film, wherein the first optically functional film further comprises a polarization layer, the polarization layer comprises a flat upper surface and a flat bottom surface, the flat bottom surface of the polarization layer and the flat upper surface of the brightness enhancement layer are attached to each other with a second optical cement, and the upper surface of the polarization layer is deposited on the bottom surface of the first display panel.

The display module with an optically functional film, wherein the upper surface of the first conversion layer and the bottom surface of the second conversion layer are attached to each other with a third optical cement, no air gap exists between the upper surface of the first conversion layer and the bottom surface of the second conversion layer, the flat bottom surface of the diffusion layer and the upper surface of the second conversion layer are attached to each other with a fourth cement of no air gap, and no air gap exists between the flat bottom surface of the diffusion layer and the upper surface of the second conversion layer.

The display module with an optically functional film, wherein the first optically functional film further comprises a brightness enhancement layer, the brightness enhancement layer has a flat upper surface and a flat bottom surface, the flat bottom surface of the brightness enhancement layer and the flat upper surface of the diffusion layer are attached to each other with a fifth optical cement.

The display module with an optically functional film, wherein the first optically functional film further comprises a polarization layer, the polarization layer comprises a flat upper surface and a flat bottom surface, the flat bottom surface of the polarization layer and the flat upper surface of the brightness enhancement layer are attached to each other with a sixth optical cement, and the upper surface of the polarization layer is deposited on the bottom surface of the first display panel.

The display module with an optically functional film, wherein the first, the second, the third, the fourth, the fifth, and the sixth optical cements are cements of matching index of refraction.

The display module with an optically functional film, wherein the light guide module comprises a first light guide plate and a second light guide plate next to the first light guide plate, the first light guide plate is deposited on the first optically functional film, and the second light guide plate is deposited on the second optically functional film.

The display module with an optically functional film, wherein the first display panel and the second display panel are transflective liquid crystal display panels.

The display module with an optically functional film of the present invention integrates the components of the optically functional film that include the first conversion layer, the second conversion layer, the brightness enhancement layer, the diffusion layer, and the polarization layer, by the transfer-coating process and the matching of the indices of refraction, which may reduce the thickness of the optically functional film and the whole volume of the double-sided display module without the brightness sacrifice of the display module.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a side-view schematic diagram illustrating a double-sided display module according to the present invention.

FIG. 2 is a side-view schematic diagram illustrating an optically functional film of the first exemplary double-sided display module according to the present invention.

FIG. 3 is a side-view schematic diagram illustrating an optically functional film of the second exemplary double-sided display module according to the present invention.

FIG. 4 is a side-view schematic diagram illustrating an optically functional film of the third exemplary double-sided display module according to the present invention.

FIG. 5 is a side-view schematic diagram illustrating an optically functional film of the fourth exemplary double-sided display module according to the present invention.

FIG. 6 is a side-view schematic diagram illustrating an optically functional film of the fifth exemplary double-sided display module according to the present invention.

FIG. 7 is a side-view schematic diagram illustrating an optically functional film of the sixth exemplary double-sided display module according to the present invention.

FIG. 8 is a side-view schematic diagram illustrating another double-sided display module according to the present invention.

### DETAILED DESCRIPTION OF THE PREFERRED EMBODIMENT

The present invention relates a double-sided display module. Some lighting technology by a lighting element and display technology by a display panel used in the double-sided display module are well understood by one skilled in the art and not described in detail in the following paragraphs. Furthermore, the presently described embodiments will be understood by reference to the drawings, and the drawings are not necessarily to scale, and the size and relative sizes of the layers and regions may have been exaggerated for clarity.

The present invention relates to a double-sided display module with an optically functional film, and particularly relates to a double-sided display module including a double-sided display, an optical module, and a display controller.

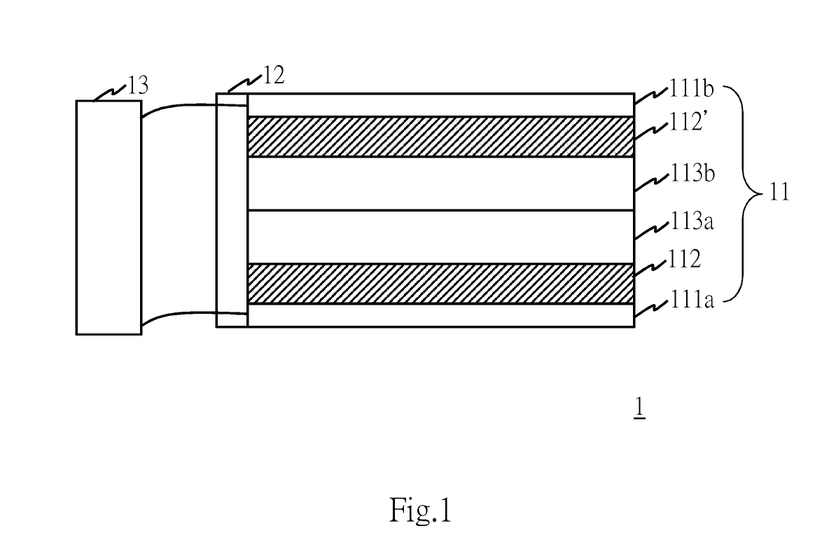

First, FIG. 1 is a schematic diagram illustrating a double-sided display module according to the present invention.

As shown in FIG. 1, a double-sided display module of the present invention includes a double-sided display 11, a lighting module 12, and a display controller 13. The lighting module 12 is deposited at one side of the double-sided display 11, and its position is just for sure not to block the double-sided display 11 for display. The display controller 13 is electrically coupled to the double-sided display 11, and the lighting module 12 irradiates the double-sided display 11 with point light. The display controller 13 outputs power and signals to the double-sided display 11 by the well-known ways that are familiar to one skilled in the arts.

Please refer to FIG. 1 again, the double-sided display 11 is consisted of a first display panel 111a, a second display panel 111b, a first optically functional film 112, a second optically functional film 112′, and a light guide module including a first light guide plate 113a and a second light guide plate 113b. The display screen direction of the first display panel 111a differs 180 degrees from the one of the second display panel 111b. One side of the first display panel 111a is electrically coupled to the display controller 13 by a suitable way to transmit electrical and data signals. The first optically functional film 112 is deposited onto the first display panel 111a, the first light guide plate 113a is on the first optically functional film 112, and the light-guiding surface (an output surface for guiding light towards the display panel) of the first light guide plate 113a faces the first optically functional film 112. The second light guide plate 113b is deposited on the first light guide plate 113a, and the light-guiding surface of the second light guide plate 113b faces the second optically functional film 112′. The light-guiding surface of the first light guide plate 113a and the light-guiding surface of the second light guide plate 113b are arranged in a back-to-back type. The second optically functional film 112′ is deposited on the second light guide plate 113b, and the second display panel 111b is deposited on the second optically functional film 112′. One side of the second display panel 111b is electrically coupled to the display controller 13 by a suitable way to transmit electrical and data signals, and it is not limited to what ways are.

Next, please refer to FIG. 1 again, the lighting module 12 emits point light onto the first light guide plate 113a and the second light guide plate 113b. The first light guide plate 113a and the second light guide plate 113b are configured to change the direction of the point light and guide the point light to make the guided point light be parallel to a direction that is a normal line to the surface of the first optically functional film 112 and second optically functional film 112′. The first light guide plate 113a and the second light guide plate 113b respectively guide the point light to the first optically functional film 112 and the second optically functional film 112′. Next, the first optically functional film 112 and the second optically functional film 112′ convert the point light into linear light and area light from the linear light in sequence, and then the area light is optically processed by the first optically functional film 112 and the second optically functional film 112′. Finally, the first optically functional film 112 and the second optically functional film 112′ respectively output the processed area light to the first display panel 111a and the second display panel 111b for display.

The point light herein and after mentioned is equivalent to light emitted from a point light source. Similarly, the area light herein and after mentioned is equivalent to light emitted from an area light source, and linear light and after mentioned is equivalent to light emitted from a line light source.

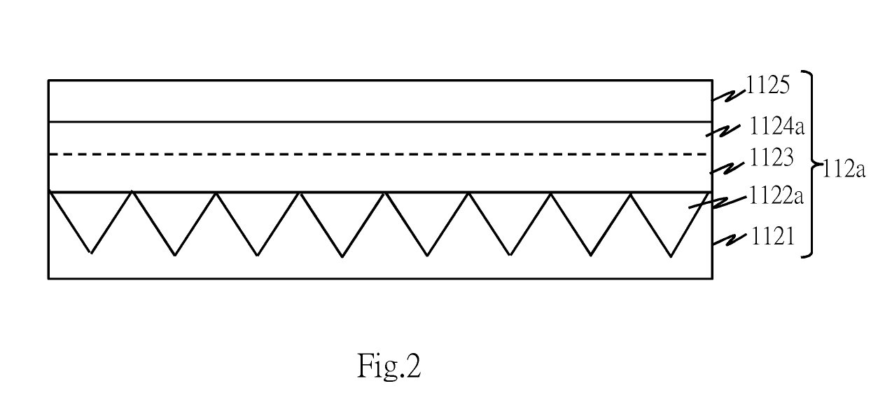

Next, FIG. 2 is a side-view schematic diagram illustrating a first optically functional film 112a of the first exemplary double-sided display module 1 according to the present invention. Because the components of the second optically functional film 112′ are the same as the ones of the first optically functional film 112a, only the components of the first optically functional film 112a will be illustrated in following paragraph.

Shown in FIG. 2, the first optically functional film 112a includes a first conversion layer 1121, a second conversion layer 1123 and a diffusion layer 1125. Both the first conversion layer 1121 and the second conversion layer 1123 have an upper surface and a bottom surface. The diffusion layer 1125 includes a flat upper surface and a flat bottom surface. Both the upper surfaces of the first conversion layer 1121 and the second conversion layer 1123 are a prism structure with a prism angle in the range of 40 to 140 degrees. The configuration direction of the first conversion layer 1121 is orthogonal to the one of the second conversion layer 1123. The upper surface of the first conversion layer 1121 and the flat bottom surface of the second conversion layer 1123 are attached to each other with their respective edges by a transfer-coating process, and an air gap 1122a is formed between the upper surface of the first conversion layer 1121 and the bottom surface of the second conversion layer 1123. The flat bottom surface of the diffusion layer 1125 and the upper surface of the second conversion layer 1123 are attached to each other with their respective edges by the transfer-coating process, and an air gap 1124a is formed between the flat bottom surface of the diffusion layer 1125 and the upper surface of the second conversion layer 1123. The upper surface of the diffusion layer 1125 is attached or deposited onto the bottom surface of the first display panel 111a. The first conversion layer 1121 converts the point light emitted from the lighting module 12 into linear light, and the second conversion layer 1123 converts the linear light from the first conversion layer 1121 into area light and outputs the area light onto the diffusion layer 1125. The diffusion layer 1125 receives the area light from the second conversion layer 1123 and homogenizes the area light to make it more homogenous. The diffusion layer 1125 outputs the homogenized area light to the first display panel 111a for displaying images. Similarly, the components of the second optically functional film 112′ are the same as the ones of the first optically functional film 112a. The upper surface of the diffusion layer 1125 of the second optically functional film 112′ is attached or deposited onto the bottom surface of the second display panel 111b, and the diffusion layer 1125 of the second optically functional film 112′ outputs the homogenized area light to the second display panel 111b.

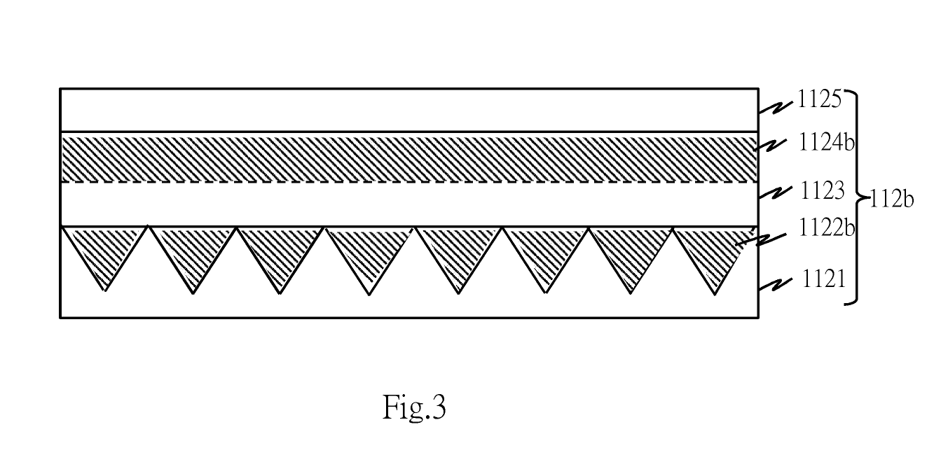

Next, FIG. 3 is a side-view schematic diagram illustrating a first optically functional film 112b of the second exemplary double-sided display module 1 according to the present invention. Because the components of the second optically functional film 112′ are same as the ones of the first optically functional film 112b, only the components of the first optically functional film 112b will be illustrated in one following paragraph.

Shown in FIG. 3, the first optically functional film 112b includes a first conversion layer 1121, a second conversion layer 1123 and a diffusion layer 1125. Both the first conversion layer 1121 and the second conversion layer 1123 have an upper surface and a bottom surface. The diffusion layer 1125 includes a flat upper surface and a flat bottom surface. Both the upper surfaces of the first conversion layer 1121 and the second conversion layer 1123 are a prism structure with a prism angle in the range of 40 to 140 degrees. The configuration direction of the first conversion layer 1121 is orthogonal to the one of the second conversion layer 1123. An air gap between the upper surface of the first conversion layer 1121 and the bottom surface of the second conversion layer 1123 is filled with optical cement 1122b. That is, the upper surface of the first conversion layer 1121 and the flat bottom surface of the second conversion layer 1123 are attached to each other with the optical cement 1122b without air gap by the transfer-coating process. The flat bottom surface of the diffusion layer 1125 and the upper surface of the second conversion layer 1123 are attached to each other with the optical cement 1124b without air gap by the transfer-coating process. The upper surface of the diffusion layer 1125 is attached or deposited onto the bottom surface of the first display panel 111a. The first conversion layer 1121 converts the point light emitted from the lighting module 12 into linear light, and the second conversion layer 1123 converts the linear light from the first conversion layer 1121 into area light and outputs the area light onto the diffusion layer 1125. The diffusion layer 1125 receives the area light from the second conversion layer 1123 and homogenizes the area light to make it more homogenous. The diffusion layer 1125 outputs the homogenized area light to the first display panel 111a for displaying images. Similarly, the components of the second optically functional film 112′ are same as the ones of the first optically functional film 112b. The upper surface of the diffusion layer 1125 of the second optically functional film 112′ is attached or deposited onto the bottom surface of the second display panel 111b, and the diffusion layer 1125 of the second optically functional film 112′ outputs the homogenized area light to the second display panel 111b.

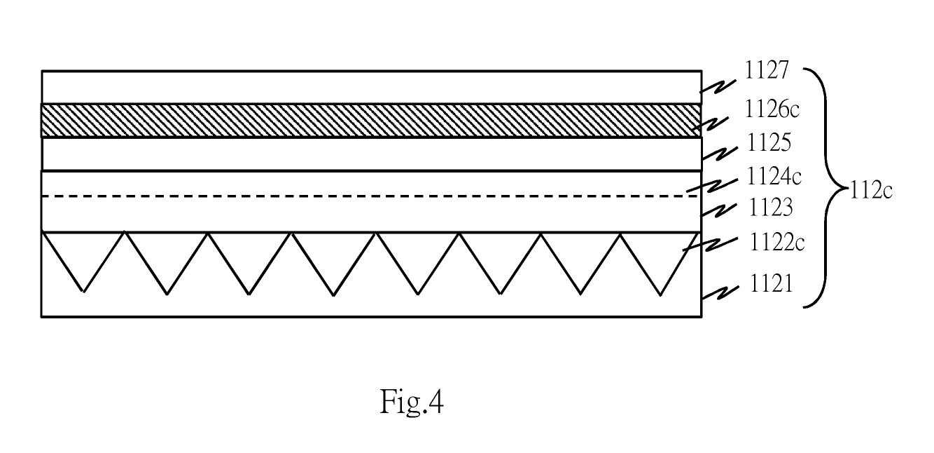

Next, FIG. 4 is a side-view schematic diagram illustrating a first optically functional film 112c of the third exemplary double-sided display module 1 according to the present invention. Because the components of the second optically functional film 112′ are same as the ones of the first optically functional film 112c, only the components of the first optically functional film 112c will be illustrated in one following paragraph.

Please refer to FIG. 4, the first optically functional film 112c includes a first conversion layer 1121, a second conversion layer 1123, a diffusion layer 1125 and a brightness enhancement layer 1127. Both the first conversion layer 1121 and the second conversion layer 1123 have an upper surface and a bottom surface. The diffusion layer 1125 includes a flat upper surface and a flat bottom surface. The brightness enhancement layer 1127 has a flat upper surface and a flat bottom surface. The upper surfaces of the first conversion layer 1121 and the second conversion layer 1123 are both a prism structure with a prism angle in the range of 40 to 140 degrees. The configuration direction of the first conversion layer 1121 is orthogonal to the one of the second conversion layer 1123. The upper surface of the first conversion layer 1121 and the flat bottom surface of the second conversion layer 1123 are attached to each other with their respective edges by the transfer-coating process, and an air gap 1122c is formed between the upper surface of the first conversion layer 1121 and the flat bottom surface of the second conversion layer 1123. The flat bottom surface of the diffusion layer 1125 and the upper surface of the second conversion layer 1123 are attached to each other with their respective edges by on the transfer-coating process, and an air gap 1124c is formed between the flat bottom surface of the diffusion layer 1125 and the upper surface of the second conversion layer 1123. The bottom surface of the brightness enhancement layer 1127 and the upper surface of the diffusion layer 1125 are attached to each other with optical cement 1126c of no air gap by the transfer-coating process. The upper surface of the brightness enhancement layer 1127 is attached or deposited onto the bottom surface of the first display panel 111a. The first conversion layer 1121 converts the point light emitted from the lighting module 12 into linear light and outputs the linear light to the second conversion layer 1123. The second conversion layer 1123 converts the linear light from the first conversion layer 1121 into area light and outputs the area light onto the diffusion layer 1125. The diffusion layer 1125 receives the area light from the second conversion layer 1123 and homogenizes the area light. The diffusion layer 1125 outputs the homogenized area light to the brightness enhancement layer 1127. The brightness enhancement layer 1127 receives and enhances the brightness of the area light from the diffusion layer 1125. Next, the brightness enhancement layer 1127 outputs the area light after brightness enhancement to the first display panel 111a for displaying images. Similarly, the components of the second optically functional film 112′ are same as the ones of the first optically functional film 112c. The upper surface of the brightness enhancement layer 1127 of the second optically functional film 112′ is attached or deposited onto the bottom surface of the second display panel 111b, and the brightness enhancement layer 1127 of the second optically functional film 112′ outputs the brightness-enhanced area light to the second display panel 111b.

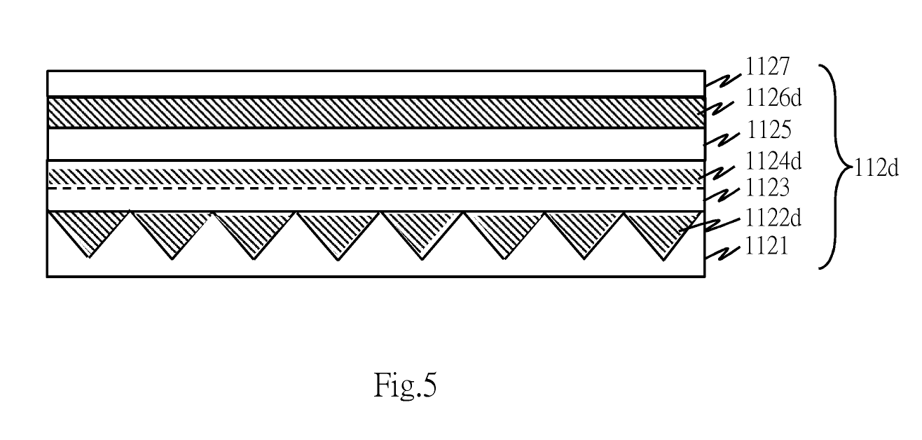

Next, FIG. 5 is a side-view schematic diagram illustrating a first optically functional film 112d of the fourth exemplary double-sided display module 1 according to the present invention. Because the components of the second optically functional film 112′ are same as the ones of the first optically functional film 112d, only the components of the first optically functional film 112d will be illustrated in one following paragraph.

Shown in FIG. 5, the first optically functional film 112d includes a first conversion layer 1121, a second conversion layer 1123, a diffusion layer 1125 and a brightness enhancement layer 1127. Both the first conversion layer 1121 and the second conversion layer 1123 have an upper surface and a bottom surface. The diffusion layer 1125 includes a flat upper surface and a flat bottom surface. The brightness enhancement layer 1127 has a flat upper surface and a flat bottom surface. The upper surfaces of the first conversion layer 1121 and the second conversion layer 1123 are both a prism structure with a prism angle in the range of 40 to 140 degrees. The configuration direction of the first conversion layer 1121 is orthogonal to the one of the second conversion layer 1123. The upper surface of the first conversion layer 1121 and the flat bottom surface of the second conversion layer 1123 are attached to each other with the optical cement 1122d of no air gap by the transfer-coating process. The flat bottom surface of the diffusion layer 1125 and the upper surface of the second conversion layer 1123 are attached to each other with the optical cement 1124d of no air gap by the transfer-coating process. The flat bottom surface of the brightness enhancement layer 1127 and the upper surface of the diffusion layer 1125 are attached to each other with the optical cement 1126d of no air gap by the transfer-coating process. The upper surface of the brightness enhancement layer 1127 is attached or deposited onto the bottom surface of the first display panel 111a. The first conversion layer 1121 converts the point light emitted from the lighting module 12 into linear light and outputs the linear light to the second conversion layer 1123, and the second conversion layer 1123 converts the linear light from the first conversion layer 1121 into area light and outputs the area light onto the diffusion layer 1125. The diffusion layer 1125 receives the area light from the second conversion layer 1123 and homogenizes the area light. The diffusion layer 1125 outputs the homogenized area light to the brightness enhancement layer 1127. The brightness enhancement layer 1127 receives the area light from the diffusion layer 1125 and enhances the brightness of the area light from the diffusion layer 1125. The brightness enhancement layer 1127 outputs the brightness-enhanced area light to the first display panel 111a for displaying images. Similarly, the components of the second optically functional film 112′ are the same as the ones of the first optically functional film 112d. The upper surface of the brightness enhancement layer 1127 of the second optically functional film 112′ is attached or deposited onto the bottom surface of the second display panel 111b, and the brightness enhancement layer 1127 of the second optically functional film 112′ outputs the brightness-enhanced area light to the second display panel 111b.

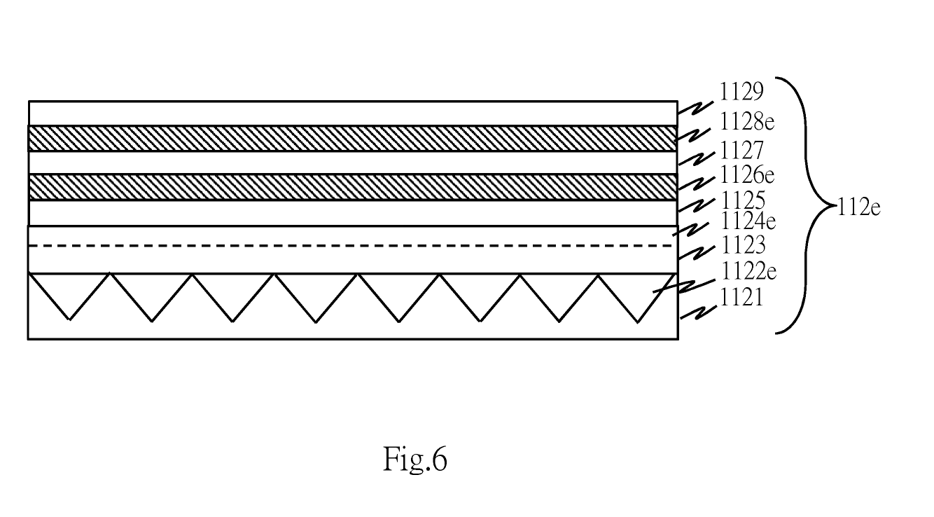

Next, FIG. 6 is a side-view schematic diagram illustrating a first optically functional film 112e of the fifth exemplary double-sided display module 1 according to the present invention. Because the components of the second optically functional film 112′ are same as the ones of the first optically functional film 112e, only the components of the first optically functional film 112e will be illustrated in one following paragraph.

Shown in FIG. 6, the first optically functional film 112e includes a first conversion layer 1121, a second conversion layer 1123, a diffusion layer 1125, a brightness enhancement layer 1127, and a polarization layer 1129. Both the first conversion layer 1121 and the second conversion layer 1123 have respectively an upper surface and a bottom surface. The diffusion layer 1125 includes a flat upper surface and a flat bottom surface. The brightness enhancement layer 1127 has a flat upper surface and a flat bottom surface. The polarization layer 1129 has a flat upper surface and a flat bottom surface. The upper surfaces of the first conversion layer 1121 and the second conversion layer 1123 are both a prism structure with a prism angle in the range of 40 to 140 degrees. The configuration direction of the first conversion layer 1121 is orthogonal to the one of the second conversion layer 1123. The upper surface of the first conversion layer 1121 and the flat bottom surface of the second conversion layer 1123 are attached to each other with their respective edges by the transfer-coating process, and an air gap 1122e is formed between the upper surface of the first conversion layer 1121 and the bottom surface of the second conversion layer 1123. The flat bottom surface of the diffusion layer 1125 and the upper surface of the second conversion layer 1123 are attached to each other with their respective edges by the transfer-coating process, and an air gap 1124e is formed between the flat bottom surface of the diffusion layer 1125 and the upper surface of the second conversion layer 1123. The flat bottom surface of the brightness enhancement layer 1127 and the upper surface of the diffusion layer 1125 are attached to each other with the optical cement 1126e of no air gap by the transfer-coating process. The upper surface of the brightness enhancement layer 1127 and the upper surface of the polarization layer 1129 are attached to each other with the optical cement 1128e of no air gap by the transfer-coating process. The upper surface of the polarization layer 1129 is attached or deposited onto the bottom surface of the first display panel 111a. The first conversion layer 1121 converts the point light emitted from the lighting module 12 into linear light and outputs the linear light to the second conversion layer 1123, and the second conversion layer 1123 converts the linear light from the first conversion layer 1121 into area light and outputs the area light onto the diffusion layer 1125. The diffusion layer 1125 receives the area light from the second conversion layer 1123 and homogenizes the area light to make it more homogenous. The brightness enhancement layer 1127 is configured to enhance the brightness of the homogenized area light from the second conversion layer 1123. The polarization layer 1129 receives the brightness-enhanced area light and converts it into polarized light, and then outputs the polarized area light to the first display panel 111a for displaying images. Similarly, the components of the second optically functional film 112′ are same as the ones of the first optically functional film 112e. The upper surface of the polarization layer 1129 of the second optically functional film 112′ is attached or deposited onto the bottom surface of the second display panel 111b, and the polarization layer 1129 of the second optically functional film 112′ outputs the polarized area light to the second display panel 111b.

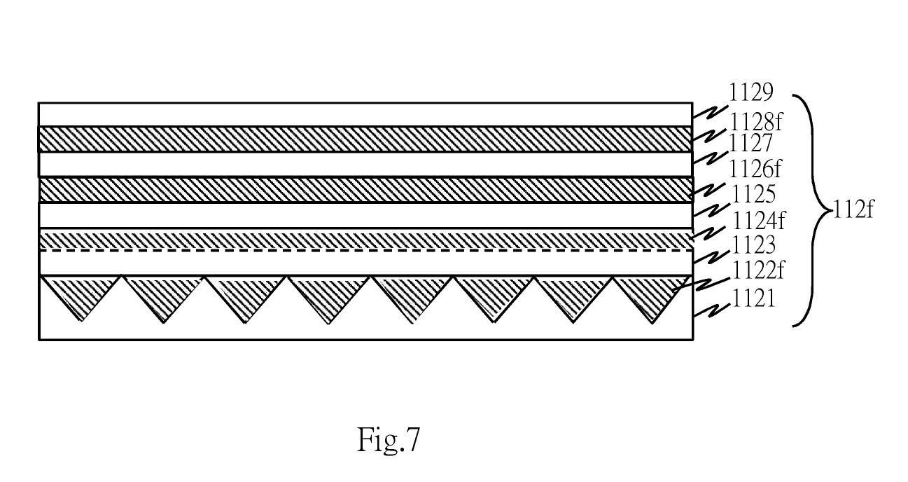

Next, FIG. 7 is a side-view schematic diagram illustrating a first optically functional film 112f of the sixth exemplary double-sided display module 1 according to the present invention. Because the components of the second optically functional film 112′ are same as the ones of the first optically functional film 112f, only the components of the first optically functional film 112f will be illustrated in one following paragraph.

Shown in FIG. 7, the first optically functional film 112f includes a first conversion layer 1121, a second conversion layer 1123, a diffusion layer 1125, a brightness enhancement layer 1127, and a polarization layer 1129. Both the first conversion layer 1121 and the second conversion layer 1123 have respectively an upper surface and a bottom surface. The diffusion layer 1125 includes a flat upper surface and a flat bottom surface. The brightness enhancement layer 1127 has a flat upper surface and a flat bottom surface. The polarization layer 1129 has a flat upper surface and a flat bottom surface. The upper surfaces of the first conversion layer 1121 and the second conversion layer 1123 are both a prism structure with a prism angle in the range of 40 to 140 degrees. The configuration direction of the first conversion layer 1121 is orthogonal to the one of the second conversion layer 1123. The upper surface of the first conversion layer 1121 and the flat bottom surface of the second conversion layer 1123 are attached to each other with the optical cement 1122f of no air gap by the transfer-coating process. The flat bottom surface of the diffusion layer 1125 and the upper surface of the second conversion layer 1123 are attached to each other with the optical cement 1124f of no air gap by the transfer-coating process. The bottom surface of the brightness enhancement layer 1127 and the upper surface of the diffusion layer 1125 are attached to each other with the optical cement 1126f of no air gap by the transfer-coating process. The bottom surface of the polarization layer 1129 and the upper surface of the brightness enhancement layer 1127 are attached to each other with the optical cement 1128f of no air gap by the transfer-coating process. The upper surface of the polarization layer 1129 is attached or deposited onto the bottom surface of the first display panel 111a. The first conversion layer 1121 converts the point light emitted from the lighting module 12 into linear light, and the second conversion layer 1123 converts the linear light from the first conversion layer 1121 into area light. The diffusion layer 1125 receives the area light from the second conversion layer 1123 and homogenizes the area light to make it more homogenous. The brightness enhancement layer 1127 is configured to enhance the brightness of the homogenized area light from the diffusion layer 1125. The polarization layer 1129 receives the brightness-enhanced area light from the brightness enhancement layer 1127 and coverts it into polarized light, and then outputs the polarized area light to the first display panel 111a for displaying images. Similarly, the components of the second optically functional film 112′ are same as the ones of the first optically functional film 112f. The upper surface of the polarization layer 1129 of the second optically functional film 112′ is attached or deposited onto the bottom surface of the second display panel 111b, and the polarization layer 1129 of the second optically functional film 112′ outputs the polarized area light to the second display panel 111b.

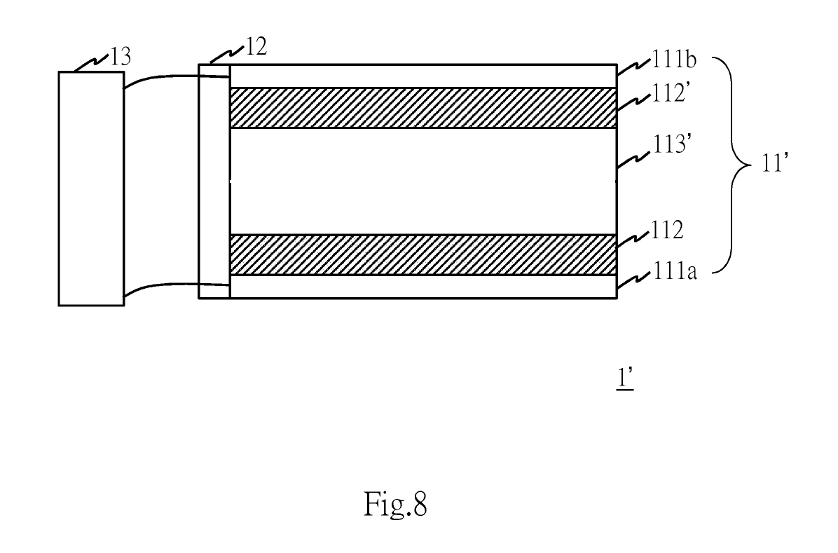

Finally, FIG. 8 is a side-view schematic diagram illustrating another double-sided display module 1′ according to the present invention. The double-sided display module 1′ may be described similar to the one in FIG. 1, and the illustration of a double-sided display 11′ may be consistent with the one in FIG. 1. Most descriptions of the first optically functional film 112 and the second optically functional film 112′ would be similar to the ones in FIGS. 2-7, but have a difference in amount of a light guide plate 113′ in FIG. 8, which is only single one. In FIG. 8, the single one light guide plate 113′ has two light guiding surfaces (guiding light towards the output surface of the display panel), and the two light guiding surfaces respectively face the first optically functional film 112 and the second optically functional film 112′.

In these embodiments aforementioned, the materials of the first conversion layer 1121 and the second conversion layer 1123 are high molecular polymer, such as resin, acrylics, and so on, but not limited in the present invention.

In these embodiments aforementioned, the optical cements 1122b, 1124b, 1126c, 1122d, 1124d, 1126d, 1126e, 1128e, 1122f, 1125f, 1126f, or 1128f is a cement of matching index of refraction. The optical cement 1122b, the optical cement 1122d, and the optical cement 1122f between the first conversion layer 1121 and the second conversion layer 1123 have the index of refraction about 1.35-1.48, respectively; the optical cement 1124b, the optical cement 1124d, and the optical cement 1124f between the second conversion layer 1123 and the diffusion layer 1125 have the index of refraction about 1.35-1.48, respectively; the optical cement 1128e and the optical cement 1128f between the brightness enhancement layer 1127 and the polarization layer 1129 have the index of refraction about 1.48-1.52, respectively; and the optical cement 1126c, the optical cement 1126d, the optical cement 1126e, and the optical cement 1126f between the diffusion layer 1125 and the brightness enhancement layer 1127 have the index of refraction about 1.48-1.52, respectively. By matching of the indices of refraction, there are tightly attachments between the first conversion layer 1121 and the second conversion layer 1123, between the brightness enhancement layer 1127, between the polarization layer 1129, between the diffusion layer 1125 and the brightness enhancement layer 1127, as well as between the second conversion layer 1123 and the diffusion layer 1125. By the transfer-coating process, individual the first conversion layers 1121, the second conversion layer 1123, the diffusion layer 1125, the brightness enhancement layer 1127, and the polarization layer 1129 of the first optically functional film 112 and the second optically functional film 112′ can be combined into one piece for reducing the thicknesses of the first optically functional film 112 and the second optically functional film 112′, respectively. Moreover, the whole volume of the double-sided display module 1 can be reduced the amount of 50%-60%, without the brightness sacrifice of the double-sided display module 1. In these embodiments aforementioned, the whole thickness of the first optically functional film 112 or the second optically functional film 112′ including the polarization layer 1129 is about 0.6 mm to 1.4 mm. The whole thickness of the first optically functional film 112 or the second optically functional film 112′ without the respective polarization layers 1129 is about 0.4 mm to 1.2 mm.

In these embodiments aforementioned, by the edge attachment methods, an air gap can be reserved between the first conversion layer 1121 and the second conversion layer 1123 of the first optically functional film 112 and the second optically functional film 112′, respectively, as well as between the second conversion layer 1123 and the diffusion layer 1125. The existence of the air gap may reduce problems of thermal expansion and contraction and enhance the reliability of the double-sided display module 1, without influences on display brightness or contrast.

In these embodiments aforementioned, the polarization layer 1129 may be an optical component capable of polarizing, such as linear polarizer, elliptic polarizer, or circuit polarizer, but not limited in the present invention.

In these embodiments aforementioned, the first display panel 111a and the second display panel 111b may be a transflective liquid crystal display panel. The details of the transflective liquid crystal display panel would refer to the contents of Taiwan Patent No. 1246619 filed in Feb. 12, 2004 and U.S. Pat. No. 6,909,486 filed in Feb. 18, 2003. The transflective liquid crystal display panel may provide viewers with clear images under its lighting environment, and not consume too much power. Moreover, the transflective liquid crystal display panel may be applied to a portable display, a desktop display or a vehicle display. The portable display may be the one of a mobile phone, a camera, and a panel computer. The desktop display may be the one of a television, a desktop computer, and a laptop computer. The vehicle display may be the one of a satellite navigator, an automobile instrument panel, and a data recorder, but not limited to. The lighting module may be a light emitting diode (LED), a cold cathode fluorescent lamp (CCFL), or electro luminescent (EL), but not limited to. For example, the lighting may be implemented by a LED light bar.

In these embodiments aforementioned, the lighting module 12 is arranged at respective one side of the double-sided display 11 or the double-sided display 11′. However, the lighting module 12 may be arranged at both sides of the double-sided display 11 or the double-sided display 11′ for improving whole display brightness, but not limited to.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A double-sided display module with optically functional films, comprising:
a double-sided display, comprising:
a first display panel;
a first optically functional film with a thickness from 0.4 mm to 1.4 mm, the first optically functional film deposited on the first display panel;
a light guide module deposited on the first optically functional film;
a second optically functional film with a thickness from 0.4 mm to 1.4 mm, the second optically functional film deposited on the light guide module; and
a second display panel deposited on the second optically functional film;
a lighting module deposited at one side of the double-sided display, the lighting module configured to emit point light to the light guide module of the double-sided display; and
a display controller electrically coupled to the first display panel and the second display panel of the double-sided display, the display controller outputting power and signal to the double-sided display;
wherein the first optically functional film and the second optically functional film respectively comprise:
a first conversion layer having an upper surface of a prism structure and a flat bottom surface, the first conversion layer configured to convert point light into linear light and output the linear light;
a second conversion layer having an upper surface of a prism structure and a flat bottom surface, the second conversion layer deposited onto the first conversion layer and configured to convert the linear light from the first conversion layer into area light and output the area light; and
a diffusion layer having a flat upper surface and a flat bottom surface, the diffusion layer deposited onto the second conversion layer and configured to homogenize the area light from the second conversion layer;
and wherein both the first optically functional film and the second optically functional film are respectively attached to the light guide module with the first conversion layer;
and wherein display screen direction of the first display panel differs 180 degrees from display screen direction of the second display panel.

2. The display module with optically functional films of claim 1, wherein the upper surface of the first conversion layer and the bottom surface of the second conversion layer are attached to each other with their respective edges, an air gap is formed between the upper surface of the first conversion layer and the bottom surface of the second conversion layer, the flat bottom surface of the diffusion layer and the upper surface of the second conversion layer are attached to each other with their respective edges, and an air gap is formed between the flat bottom surface of the diffusion layer and the upper surface of the second conversion layer.

3. The display module with optically functional films of claim 2, wherein the first optically functional film further comprises a brightness enhancement layer, the brightness enhancement layer comprises a flat upper surface and a flat bottom surface, the flat bottom surface of the brightness enhancement layer and the flat upper surface of the diffusion layer are attached to each other with a first optical cement.

4. The display module with optically functional films of claim 3, wherein the first optically functional film further comprises a polarization layer, the polarization layer comprises a flat upper surface and a flat bottom surface, the flat bottom surface of the polarization layer and the flat upper surface of the brightness enhancement layer are attached to each other with a second optical cement, and the upper surface of the polarization layer is deposited on the bottom surface of the first display panel.

5. The display module with optically functional films of claim 1, wherein the upper surface of the first conversion layer and the bottom surface of the second conversion layer are attached to each other with a third optical cement, no air gap exists between the upper surface of the first conversion layer and the bottom surface of the second conversion layer, the flat bottom surface of the diffusion layer and the upper surface of the second conversion layer are attached to each other with a fourth cement of no air gap, and no air gap exists between the flat bottom surface of the diffusion layer and the upper surface of the second conversion layer.

6. The display module with optically functional films of claim 5, wherein the first optically functional film further comprises a brightness enhancement layer, the brightness enhancement layer has a flat upper surface and a flat bottom surface, the flat bottom surface of the brightness enhancement layer and the flat upper surface of the diffusion layer are attached to each other with a fifth optical cement.

7. The display module with optically functional films of claim 6, wherein the first optically functional film further comprises a polarization layer, the polarization layer comprises a flat upper surface and a flat bottom surface, the flat bottom surface of the polarization layer and the flat upper surface of the brightness enhancement layer are attached to each other with a sixth optical cement, and the upper surface of the polarization layer is deposited on the bottom surface of the first display panel.

8. The display module with optically functional films of claim 3, wherein the first optical cement is a cement of matching index of refraction.

9. The display module with optically functional films of claim 4, wherein the second optical cement is a cement of matching index of refraction.

10. The display module with optically functional films of claim 5, wherein the third and the fourth optical cements are a cement of matching index of refraction.

11. The display module with optically functional films of claim 6, wherein the fifth optical cement is a cement of matching index of refraction.

12. The display module with optically functional films of claim 7, wherein the sixth optical cement is a cement of matching index of refraction.

13. The display module with optically functional films of claim 1, wherein the light guide module comprises a first light guide plate and a second light guide plate next to the first light guide plate, the first light guide plate is deposited on the first optically functional film, and the second light guide plate is deposited on the second optically functional film.

14. The display module with optically functional films of claim 1, wherein the first display panel and the second display panel are transflective liquid crystal display panels.
